(19) United States
(12) Patent Application Publication
(10) Pub. No.: US 2011/0302761 A1
(43) Pub. Date: Dec. 15, 2011

(54) PROCESS FOR MANUFACTURING AN ANODIZED ALUMINUM DISC SEAL SHELL

(75) Inventor: Michael P. Dupuis, Westfield, MA (US)

(73) Assignee: International Metal Products, Inc., Chicopee, MA (US)

(21) Appl. No.: 13/160,249

(22) Filed: Jun. 14, 2011

Related U.S. Application Data
(60) Provisional application No. 61/354,297, filed on Jun. 14, 2010.

(51) Int. Cl. B23P 11/00; C25D 7/00; C25D 5/02

(52) U.S. Cl. 29/428; 205/122; 205/149

(57) ABSTRACT

A method is provided for manufacturing an anodized disc seal shell for a container. The method includes: providing a metal disc seal shell having a surface; masking a portion of the surface to provide a masked surface and an unmasked surface; anodizing the unmasked surface; and removing the masking from the masked surface to provide an un-anodized surface.

This application claims priority to U.S. Provisional Application No. 61/354,297, which is hereby incorporated by reference in its entirety.

### BACKGROUND OF THE INVENTION

1. Technical Field

This disclosure relates generally to a disc seal shell for sealing a container and, more particularly, a method for manufacturing an anodized disc seal shell and a method for sealing a container with an anodized disc seal shell.

2. Background Information

A container can be sealed with a disc seal shell to avoid contamination and spillage of its contents. Bottles and vials that hold consumables such as vitamins, nutritional supplements, pharmaceuticals or medicines are examples of a container. Such a container is typically assembled and sealed under “clean room” conditions. The container can be sealed by crimping edges of the disc seal shell around a lip of the container.

The disc seal shell can be manufactured from metal, and can be color coded for particular applications. The metal can be anodized to increase its corrosion resistance and wear resistance during the assembly process. The metal can also be anodized to increase its adhesion to paint primers and glues. Anodized metals, however, typically do not crimp or seal as well as non-anodized metals.

### SUMMARY OF THE INVENTION

According to a first aspect of the invention, a method is provided for manufacturing an anodized disc seal shell for a container. The method includes: (a) providing a metal disc seal shell having a surface; (b) masking a portion of the surface to provide a masked surface and an unmasked surface; (c) anodizing the unmasked surface; and (d) removing the masking from the masked surface to provide an un-anodized surface.

According to a second aspect of the invention, a method is provided for manufacturing an anodized disc seal shell for a container. The method includes: (a) providing a metal disc seal shell having a surface; (b) anodizing the surface to provide an anodized coating on the surface; and (c) removing a portion of the anodized coating to provide an un-anodized surface and an anodized surface.

According to a third aspect of the invention, a method is provided for sealing a container. The method includes: (a) providing a metal disc seal shell having an un-anodized surface and an anodized surface; and (b) connecting the un-anodized surface to the container.

### BRIEF DESCRIPTION OF THE DRAWINGS

FIG. 1 is a diagrammatic illustration of a disc seal shell.

FIG. 2 is a diagrammatic illustration of a disc seal shell connected to a container.

### DETAILED DESCRIPTION OF THE INVENTION

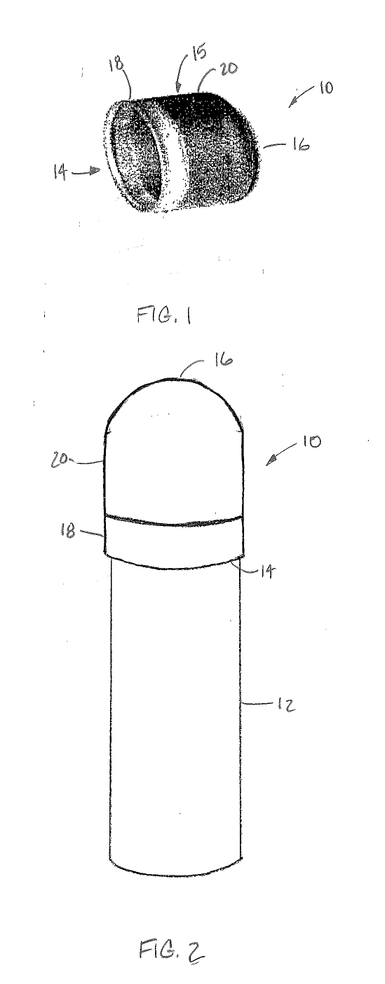

Referring to FIGS. 1 and 2, a disc seal shell 10 is shown for sealing a container 12. An example of a container 12 is a bottle or vial that holds consumables such as vitamins, nutritional supplements, pharmaceuticals and medicines. Such a container 12 can be constructed from variety of materials including glass, plastic and metal. The disc seal shell 10 can be manufactured in many different shapes, sizes and material thicknesses in order to fit on a variety of different types of containers. The disc seal shell 10 can also be anodized.

Aluminum alloys can be anodized to increase their corrosion resistance, to increase their surface hardness, to facilitate dyeing (i.e., coloring) of the alloy, to improve lubrication, and/or to improve adhesion to the alloy. The anodic layer is non-conductive.

When exposed to air at room temperature, or any other gas containing oxygen, pure aluminum self-passivates by forming a surface layer of amorphous aluminum oxide (e.g., 2 to 3 nm thick), which provides relatively effective protection against corrosion. Aluminum alloys typically form a thicker oxide layer (e.g., 5-15 nm thick), but tend to be more susceptible to corrosion than pure aluminum. Aluminum alloy parts, however, can be anodized to significantly increase the thickness of the oxide layer to increase corrosion resistance. Although anodizing has moderate wear resistance, deeper pores in the oxide layer can retain a lubricating film better than a smooth surface.

Anodized coatings can have a significantly lower thermal conductivity and coefficient of linear expansion than aluminum. The coating therefore can crack from thermal stress when exposed to temperatures above, for example, eighty degrees Celsius (80° C.). Such a coating, however, in general will not peel. The melting point of aluminum oxide is significantly higher than the melting point of pure aluminum (e.g., 658° C.), which can make welding difficult.

In typical commercial aluminum anodize processes, the aluminum oxide is anodized down into the surface and out from the surface of the aluminum by equal amounts. The anodizing therefore increases dimensions on a surface of a part by half of the oxide thickness. For example a coating that is (2 μm) thick, can increase the part dimensions by (1 μm) per surface. Where the part is anodized on all sides, each linear dimension will increase by the oxide thickness. Anodized aluminum surfaces are harder than aluminum, but have low to moderate wear resistance, although this can be improved with thickness and sealing.

Referring again to FIGS. 1 and 2, the disc seal shell 10 has a surface 15 that extends from an opening 14 to a distal end 16. The surface 15 includes an un-anodized surface 18 and an anodized surface 20. The un-anodized surface 18 is located adjacent the opening 14, and the anodized surface 20 is located adjacent the distal end 16. The un-anodized surface 18 is operable to be crimped to the container 12 (see FIG. 2) to form a seal therebetween. By not anodizing the un-anodized surface 18, it allows the shell 10 to better crimp to the container 12. In addition, the crimped area (i.e., the un-anodized surface 18) is best not anodized because the anodizing coating can crack and craze during the crimping process. This would create contamination particles in a clean room environment and possibly contaminate the contents of the container 12.

During a manufacturing process, an edge of the disc seal shell 10 located adjacent the opening 14 is masked (e.g., protected) prior to anodizing. The crimping area can be covered, for example, with a masking that can include a plastic, lacquer, press fit aluminum, rubber or any material that would prevent that area from receiving the anodizing. Alternatively, an anodized coating can be removed from the edge of the shell 10 so that the edge of the shell 10 can be crimped. The crimp holds and forms best when the aluminum is not anodized on the crimping area. Aluminum is more ductile than anodized aluminum which allows the aluminum better plastic deformation when crimped. The masking process can be performed, for example, using one of the following methods:

(1) The shell 10 can be masked before anodizing thus not allowing the anodized coating to form on the masked area. The shell 10 may be coated, for example, with a masking to cover the portion not to be anodized. The masking is removed after anodizing. Alternatively, the part can be press fit onto a carrier strip which can act as a masking. The carrier strip can also act as a conductor during the anodizing. The disc seal shell 10 is subsequently removed from the carrier strip after the anodizing The disc seal shell 10 can also be press fit onto an anodized rack and subsequently anodized.

(2) The shell 10 can be anodized and then masked so as to remove the anodized coating from the edge of the seal which will be crimped. The removal of the anodizing could be done several different ways. The anodized coating can be, for example, chemically removed from the area after the part is anodized to reveal an un-anodized surface using a chemical which will dissolve the anodized coating. The anodized coating can alternatively be mechanically removed from the desired area with machinery, for example, to effectively sand blast it off using many different kinds of blasting media, or other methods.

The disc seal shell 10 can be full anodized except for the very edge which is to be crimped around the opening of the container 12. The edge is masked, as indicated above, either before or after anodizing to either prevent the anodizing coating from being anodized on to the edge or removing the anodizing coating from the edge prior to crimping. In this manner, the disc seal shell 10 may be color coded to achieve an additional feature of colored seals to indicate a characteristic of the contents of the container 12, as required for the particular application. The anodized metal has greater wear resistance and adhesion characteristics during the assembly process and also has a better seal when the shell 10 is crimped. The area with no anodize on the shell 10 also eliminates the possibility of contamination to a clean room environment or to the contents of the bottle or vial by not generating anodizing particles.

While various embodiments of the present invention have been disclosed, it will be apparent to those of ordinary skill in the art that many more embodiments and implementations are possible within the scope of the invention. Accordingly, the present invention is not to be restricted except in light of the attached claims and their equivalents.

What is claimed is:

1. A method for manufacturing an anodized disc seal shell for a container, comprising:
providing a metal disc seal shell having a surface;
masking a portion of the surface to provide a masked surface and an unmasked surface;
anodizing the unmasked surface; and
removing the masking from the masked surface to provide an un-anodized surface.

2. The method of claim 1, wherein the un-anodized surface is located adjacent an open end of the disc seal shell.

3. The method of claim 1, wherein the metal comprises one of aluminum and aluminum alloy.

4. The method of claim 1, wherein the masking comprises one of plastic, lacquer, press fit aluminum, and rubber.

5. The method of claim 1, wherein the masking of the portion of the surface comprises press fitting the portion of the surface onto one of a carrier strip and an anodized rack.

6. The method of claim 5, further comprising utilizing the carrier strip as a conductor during the anodizing of the unmasked surface.

7. The method of claim 1, further comprising dyeing the anodized surface of the disc seal shell.

8. A method for manufacturing an anodized disc seal shell for a container, comprising:
providing a metal disc seal shell having a surface;
anodizing the surface to provide an anodized coating on the surface; and
removing a portion of the anodized coating to provide an un-anodized surface and an anodized surface.

9. The method of claim 8, wherein the un-anodized surface is located adjacent an open end of the disc seal shell.

10. The method of claim 8, wherein the metal comprises one of aluminum and aluminum alloy.

11. The method of claim 8, wherein the removing of the portion of the anodized coating comprises chemically dissolving the portion of the anodized coating.

12. The method of claim 8, wherein the removing of the portion of the anodized coating comprises mechanically removing the portion of the anodized coating.

13. The method of claim 8, further comprising dyeing the anodized surface.

14. A method for sealing a container, comprising:
providing a metal disc seal shell having an un-anodized surface and an anodized surface; and
connecting the un-anodized surface to the container.

15. The method of claim 14, wherein the un-anodized surface is located adjacent an open end of the disc seal shell.

16. The method of claim 14, wherein the metal comprises one of aluminum and aluminum alloy.

17. The method of claim 14, wherein the connecting of the un-anodized surface to the container comprises crimping the un-anodized surface to the container.

18. The method of claim 14, wherein the connecting of the un-anodized surface to the container is performed under clean room conditions.

19. The method of claim 14, wherein the anodized surface is dyed to indicate a characteristic of the contents of the container.
